(19) United States
(12) Patent Application Publication
(10) Pub. No.: US 2015/0166940 A1
(43) Pub. Date: Jun. 18, 2015

(54) UNIVERSAL SURFACE DECONTAMINATION FORMULATION

(71) Applicant: Her Majesty the Queen in Right of Canada, as Represented by the Minister of Environment, Gatineau (CA)

(72) Inventors: Konstantin Volchek, Nepean (CA); Pervez Azmi, Nepean (CA); Wenxing Kuang, Gloucester (CA); Carl E. Brown, Orleans (CA)

(21) Appl. No.: 14/616,586

(22) Filed: Feb. 6, 2015

Related U.S. Application Data
(63) Continuation of application No. 13/653,283, filed on Oct. 16, 2012.

(30) Foreign Application Priority Data
Jul. 18, 2012 (CA) 2783349

(51) Int. Cl. C11D 7/10; C11D 7/32; C11D 7/26; A01N 43/66

(52) U.S. Cl. CPC C11D 7/10; A01N 43/66; C11D 7/32; C11D 7/265; C11D 7/105

(57) ABSTRACT

Provided are decontamination compositions that include an ammonium compound, a ferric/ferrocyanide compound, a polyaminocarboxylic acid compound and a polycarboxylic compound. Depending on the mode of application, the compositions can be used as foams, liquids, gels, strippable coatings, mists, or in other forms. Also provided are kits that include such components in whole or in part along with an optional dispersing device for use of the decontamination composition.

### CROSS-REFERENCE TO RELATED APPLICATIONS

This application is a continuation of application Ser. No. 13/653,283 filed Oct. 16, 2012 which claims the priority of Canadian application no. 2783349 filed Jul. 18, 2012.

### FIELD OF INVENTION

The present invention relates to decontamination formulations. More specifically, the present invention relates to decontamination formulations for chemical, biological, and/or radiological decontamination.

### BACKGROUND OF THE INVENTION

In view of the high degree of urbanization, the impact from an event resulting in the dispersal of harmful chemical, biological or radiological substances in populated or urban areas can be significant. In dealing with any contaminants, decontamination techniques and compositions need to be tailored to the nature of the contaminants and also the materials to be decontaminated.

Decontamination from chemical or biological agents often involves employing methods and compositions that alter or destroy the chemical structure of the chemical or biological agent rendering it non-toxic or less toxic. Thus, the strategy to decontaminate materials containing such agents is not applicable to other contamination problems, particularly contaminating agents which cannot be created or destroyed, such as heavy metals or radiological agents. Decontamination from these agents from surfaces can require different strategies and/or compositions from those described above.

In the event of an accidental release of radionuclides or in the event of terrorist attack, the isotopes of greatest concern would likely be ¹³⁴Cs, ¹³⁷Cs, ⁸⁵Sr, ⁹⁰Sr and ⁶⁰Co, that can be found in industrial radiography and irradiator sources, nuclear medical sources, and portable gauges. One possible method of decontaminating sites following radionuclide contamination is through mechanical decontamination, for example, removal of the surface that is contaminated with the radiological agent.

Many mechanical decontamination technologies involve aggressive methods such as blasting, cutting, surface removal and/or scrubbing. Although these techniques have proven effective in some instances, for example during the Chernobyl accident decontamination, due to their destructive nature, they may not be suitable for decontaminating various surfaces including buildings of historical importance. For such scenarios, chemical decontamination may be a better alternative. Among the wide variety of chemical methods used for the decontamination of radioactive metal ions from surfaces, chemical removal using compositions comprising binding agents that sequester the radionuclides is one widely used procedure. However, chemical methods may have drawbacks, including lack of non-specific binding to a variety of metal ions, as well as potentially promoting radionuclide mobility.

There are many decontamination compositions and techniques known in the art for decontaminating chemical, biological or radionuclide agents depending on the nature of the contaminating agent and the contaminated material. Examples of such compositions and techniques are described in U.S. Pat. Nos. 7,915,472; 8,070,881; 7,833,357; 7,390,432; 6,723,890; 6,566,574; 6,652,661; 6,525,237; 5,961,736 and 5,512,202 which are herein incorporated by reference.

There is a need in the art for novel decontamination compositions and formulations. Further, there is a need in the art for universal decontamination compositions that are effective against radionuclide, chemical and biological agents simultaneously. This is particularly important when the nature of the threat (chemical, biological or radiological) is unknown. Also, when both radiological and chemical and/or biological agents are present, decontaminating with a single composition or in one step, as opposed to decontaminating with multiple compositions or in two or more steps, should simplify decontamination operations and reduce their overall cost and time.

### SUMMARY OF THE INVENTION

The present invention relates to decontamination formulations. More specifically, the present invention relates to decontamination formulations for chemical, biological, or radiological decontamination. The present invention further relates to formulations for simultaneous decontamination from chemical, biological, and radiological agents.

According to an embodiment of the present invention there is provided a decontamination composition comprising an ammonium compound, a ferric cyanide compound, a polyaminocarboxylic acid compound and a polycarboxylic acid compound. The decontamination composition may be a solid composition or may be an aqueous composition. In a preferred embodiment, the decontamination composition comprises ammonium nitrate, potassium ferricyanide, nitrilotriacetate and sodium citrate.

In a further embodiment of the present invention, there is provided the decontamination composition as described above comprising 0.0001-15% by weight of the ammonium compound, 0.0001-15% by weight ferri/ferrocyanide compound, 0.0001-20% by weight polyaminocarboxylic acid, and 0.0001-20% by weight polycarboxylic acid compound. In a preferred embodiment, the ammonium compound is ammonium nitrate, the ferri/ferrocyanide compound is potassium ferricyanide, the polyaminocarboxylic acid compound is nitrilotriacetate and the polycarboxylic acid compound is sodium citrate.

The present invention also contemplates the decontamination composition as described above, formulated for dispersal as a foam, a liquid, a gel, a strippable coating, or a mist. Any other dispersal formulation known in the art is also contemplated. In a preferred embodiment, the decontamination composition is a foam.

The present invention also contemplates the decontamination composition as described above further comprising of one or more oxidizing agents, one or more surfactants, one or more buffering agents, propylene glycol, polyethylene glycol, derivatives of propylene glycol, derivatives of ethylene glycol, or any combination thereof.

The present invention further provides decontamination compositions as described above comprising a) ammonium ions; b) hexacyanoferrate, c) citrate, d) nitrilotriacetic acid, e) dichloroisocyanuric acid, f) carbonate, g) one or more surfactants comprising sodium myristeth sulfate, C14-C16 olefin sulfonate, denatured ethanol, or C10-C16 alcohols and h) polyethylene glycol or a derivative thereof.

Also provided are kits comprising,
a) one or more of an ammonium compound, a ferric cyanide compound, a polyaminocarboxylic acid compound and a citrate compound,
and;
b) one or more components for preparing or formulating a decontamination composition, the one or more components in separated form, combined in solid form, combined in liquid form or dissolved in liquid/aqueous form, one or more mixers, pumps, hoses, containers, nozzles, aerators, water, and instructions for using or formulating any component or group of components in the kit.

Also provided are kits as described above comprising a decontamination composition formulated for dispersal and a dispersing system. In a preferred embodiment, the decontamination composition is formulated for dispersal as a foam. In a further embodiment the decontamination composition is a liquid or aqueous composition. In an alternate embodiment, the decontamination composition is formulated, maintained or stored as a solid composition.

This summary of the invention does not necessarily describe all features of the invention.

### DETAILED DESCRIPTION OF THE INVENTION

The following description is of a preferred embodiment.

The term “composition” and “formulation” are used interchangeably herein.

The present invention provides surface decontamination compositions/formulations for decontaminating surfaces from chemical, biological and radiological contaminants. In an embodiment, there is provided a decontamination composition comprising an ammonium compound, a ferricyanide compound, a polyaminocarboxylic acid compound, and a polycarboxylic acid compound. In further embodiments, there is provided decontamination compositions which comprise one or more of an ammonium compound, a ferricyanide compound, a polyaminocarboxylic acid compound, or a polycarboxylic acid compound.

By “ammonium compound” it is meant an ammonium salt, for example, but not limited to ammonium chloride, nitrate, sulfate, carbonate and the like. Any compound that generates ammonium ions in solution is contemplated herein. In a preferred embodiment, the ammonium compound is ammonium nitrate. Quarternary ammonium compounds or alkyl ammonium salts also may be employed in the compositions and methods described herein.

By “ferri/ferrocyanide compound” it is meant any salt of ferricyanide or ferrocyanide, for example, but not limited to potassium ferricyanide (K₃Fe(CN)₆), sodium ferricyanide (Na₃Fe(CN)₆), ammonium ferricyanide, copper ferrocyanide, zinc ferrocyanide, iron (III) ferrocyanide, nickel ferrocyanide and the like or any combination thereof. In a preferred embodiment the ferri/ferrocyanide compound is potassium ferricyanide (K₃Fe(CN)₆).

By “polyaminocarboxylic acid compound” it is meant any salt of a compound which comprises one or more nitrogen atoms connected through carbon atoms to one or more carboxyl groups, and is capable of chelating metal ion. For example, a nitrilotriacetate salt is a representative polyaminocarboxylic acid compound, as are EDTA, DTPA, EGTA, NOTA, DOTA and the like. In a preferred embodiment, the polyaminocarboxylic acid is trisodium nitrilotriacetate.

By “polycarboxylic acid compound” it is meant any carboxylic acid or its salt containing two or more carboxylic groups. Representative examples of such compounds include, but are not limited to the sodium salt of citric acid (sodium citrate), potassium citrate, calcium citrate and the like. Also contemplated as polycarboxylic acids are compounds, such as, but not limited to oxalate, folate, fumarate, glutamate, succinate, aspartate, tartarate and the like, or any combination thereof. In a preferred embodiment, the polycarboxylic acid compound is a citrate compound, for example, mono-, di-, or trisodium citrate, ammonium citrate, ferric ammonium citrate, potassium citrate, calcium citrate, magnesium citrate or any combination thereof.

In an embodiment, which is not meant to be limiting in any manner, the ammonium compound comprises about 0.0001% to 50% by weight of the surface decontamination composition, more preferably about 0.001% to 20% (w/w), still more preferably about 0.01% to 15% (w/w), even more preferably about 1-15% (w/w). For example, but not to be considered limiting, the ammonium compound may be present in an amount of 1%, 2%, 3%, 4%, 5%, 6%, 7%, 8%, 9%, 10%, 11%, 12%, 13%, 14% or 15%. The compound may also be present in amounts between any of the values listed above or, the compound may be present in a range of amounts represented by any two of the values noted above or herein or any values therein between. In a further embodiment, in instances wherein the composition is a liquid composition, it is contemplated that the decontamination composition comprises compounds as described herein in an amount up to their saturation point in solution.

In an embodiment of the present invention, which is not meant to be limiting in any manner, the ferri/ferrocyanide compound comprises about 0.0001% to 50% by weight of the surface decontamination composition, more preferably about 0.001% to 20% (w/w), still more preferably about 0.01% to 15% (w/w). In a further embodiment, in instances wherein the composition is a liquid composition, it is contemplated that the decontamination composition comprises compounds as described herein in an amount up to their saturation point.

In an embodiment of the present invention, which is not meant to be limiting in any manner, the polyaminocarboxylic acid compound comprises about 0.0001% to 50% by weight of the surface decontamination composition, more preferably about 0.001% to 20% (w/w), still more preferably about 0.01% to 20% (w/w). In a further embodiment, in instances wherein the composition is a liquid composition, it is contemplated that the decontamination composition comprises compounds as described herein in an amount up to their saturation point.

In an embodiment of the present invention, which is not meant to be limiting in any manner, the polycarboxylic acid compound comprises about 0.0001% to 50% by weight of the surface decontamination composition, more preferably about 0.001% to 20% (w/w), still more preferably about 0.01% to 20% (w/w). In a further embodiment, in instances wherein the composition is a liquid composition, it is contemplated that the decontamination composition comprises compounds as described herein in an amount up to their saturation point.

It is generally preferred that all four compounds (ammonium compound, ferri/ferrocyanide compound, polyaminocarboxylic acid compound, and polycarboxylic acid compound are present in the surface decontamination composition. However, the present invention also contemplates compositions that comprise any one, any two, any three or all four of the compounds discussed above. Representative examples, which are not meant to be limiting in any manner are provided herein.

The surface decontamination composition may be formulated for delivery and use in a variety of ways. For example, the surface decontamination composition may comprise water, an aqueous solution, foam, gel, mist, strippable coating or a combination thereof. Accordingly, the components of the surface decontamination composition as described herein and throughout may comprise a plurality of additional components as would be known in the art. In particular, the surface decontamination compositions as described herein may further comprise one or more additional components, or may be prepared or formulated, for example, as described in any of Canadian Patent: 2,300,698; U.S. Pat. No. 6,525,237 or EP Patent 1,154,820 entitled “Broad Spectrum Decontamination Formulation and Method of Use” and Canadian Patent: 2,299,259 and U.S. Pat. No. 6,405,626 entitled “Decontamination and Dispersal Suppressing Foam Formulation”, the disclosures and references of which are herein incorporated by reference in their entirety.

In a further embodiment of the present invention, which is not meant to be limiting in any manner, the composition comprises one or more oxidizing agents, such as, but not limited to an isocyanuric acid. Preferably the isocyanuric acid is an alkali metal salt of isocyanuric acid, for example, but not limited to sodium dichloroisocyanuric acid or the like.

In examples wherein the decontamination composition comprises an isocyanuric acid, preferably it is present in an amount of from about 0.1% to 25% by weight, more preferably about 1% to about 20%, still more preferably about 2% to 10%. In a preferred embodiment, the present invention comprises the sodium salt of dichloroisocyanuric acid as this component is readily available from a variety of chemical suppliers.

As suggested above, the decontamination composition contemplates aqueous compositions/formulations, but a variety of additional solvents or co-solvents also may be included. Examples of additional solvents or co-solvents include, but are not limited to propylene glycol, polyethylene glycol, derivatives of propylene glycol, derivatives of ethylene glycol, or any combination thereof. When present, such solvents are generally present in an amount of from about 0.1 to about 20% by volume, more preferably 1% to 10%, for example, but not limited to 1%, 2%, 3%, 4%, 5%, 6%, 7%, 8%, 9%, or 10% by volume.

The decontamination composition also may comprise one or more surfactants. In an embodiment of the present invention, the surfactant is present in an amount of from about 0.01% to about 20% by weight, more preferably about 1% to about 15% and still more preferably from about 1% to about 10%, for example, 1%, 2%, 3%, 4%, 5%, 6%, 7%, 8%, 9% or 10% by weight. Various surfactants may be used in the decontamination composition of the present invention, for example those described in U.S. Pat. No. 6,525,237 and U.S. Pat. No. 6,405,626 which are incorporated by reference in their entirety. Other surfactants known in the art are also contemplated.

In an embodiment, the surfactant is provided as a surfactant component system, for example, comprising an alkyl ether sulphate salt, an alkyl alcohol, an alpha olefin sulfonate or a combination thereof, for example, but not limited to sodium myristeth sulfate, sodium C14-C16 olefin sulfonate, ethanol, denatured ethanol, long chain alcohols, for example, but not limited to C10-C16 alcohols, or a combination thereof.

According to a further embodiment, there is provided a surfactant component system that comprises sodium myristeth sulfate in an amount of about 1% to 40% by weight, more preferably about 5% to 35%, still more preferably about 10 to 30%, for example, but not limited to about 10%, 11%, 12%, 13%, 14%, 15%, 16%, 17%, 18%, 19%, 20%, 21%, 22%, 23%, 24%, 25%, 26%, 27%, 28%, 29% or 30%.

The decontamination composition may further comprise a C14-C16 olefin sulfonate, for example, sodium C14-C16 olefin sulfonate in an amount of about 1% to 40% by weight, more preferably about 5% to 35%, still more preferably about 10% to 30%, for example, but not limited to 10%, 11%, 12%, 13%, 14%, 15%, 16%, 17%, 18%, 19%, 20%, 21%, 22%, 23%, 24%, 25%, 26%, 27%, 28%, 29% or 30%.

The decontamination composition may further comprise ethanol or denatured ethanol in an amount of about 1% to about 20% by volume, more preferably about 2% to 15%, still more preferably about 3% to 9%, for example, but not limited to about 3%, 4%, 5%, 6%, 7%, 8% or 9%.

The decontamination composition may further comprise C10-C16 alcohols in an amount of about 1% to 20% by volume, more preferably about 2% to 15%, still more preferably about 5% to 10%, for example 5%, 6%, 7%, 8%, 9%, or 10%.

The decontamination composition may further comprise sodium sulfate in the amount of about 1% to 10% by weight, more preferably about 2% to 8%, still more preferably about 3% to 7% for example 3%, 4%, 5%, 6%, or 7%.

The decontamination composition may further comprise sodium xylene sulfate in the amount of about 0.1% to 10%, more preferably about 0.2% to 8%, still more preferably about 1% to 5% for example 1%, 2%, 3%, 4%, or 5%.

The decontamination composition may further comprise one or more buffers or buffer component systems, for example, but not limited to sodium tetraborate, sodium hydroxide, and sodium carbonate. Preferably the buffer system maintains an alkaline pH, more preferably around pH 8-12, still more preferably around 10-11.

In an alternative embodiment, the decontamination compositions of the present invention may not comprise any significant buffering agents or buffer component systems. For example, the present invention includes decontamination compositions comprising ammonium nitrate, potassium hexacyanoferrate, citrate and nitrilotriacetate which are formulated in water or other non-buffered aqueous solutions.

In still other embodiments, the compounds described above may be combined as a solid composition that can readily be mixed with other aqueous or liquid components to create the surface decontamination formulations as described herein.

The decontamination composition may further comprise one or more foaming agents, or corrosion inhibitors as would be known in the art.

In a first embodiment of the present invention, which is not meant to be limiting in any manner, the decontamination composition comprises about 5-15% sodium dichloroisocyanurate, a buffer component system comprising about 0.005M-0.02M sodium tetraboratedecahydrate and about 0.05-0.2M anhydrous sodium carbonate adjusted to a pH from about 10 to 11, with NaOH, about 5-15% surfactant and about 5-15% co-solvent, and at least one component selected from the group consisting of ammonium nitrate, potassium hexacyanoferrate, trisodium citrate and nitrilotriacetate.

In a further embodiment, the decontamination composition comprises about 9% by weight sodium dichloroisocyanurate, a buffer mixture comprising about 0.0125M sodium tetraboratedecahydrate and about 0.1M anhydrous sodium carbonate adjusted to a pH from about 10 to 11, using NaOH, about 9% surfactant, about 8% co-solvent, ammonium nitrate, potassium hexacyanoferrate, trisodium citrate and nitrilotriacetate.

In a further embodiment of the present invention, the decontamination composition comprises about 6% by weight dichloroisocyanuric acid salt, an alkaline buffer, about 9% surfactant and about 8% co-solvent.

In a further embodiment of the present invention, the decontamination comprises about 3% by weight dichloroisocyanuric acid salt, an alkaline buffer, and about 3% surfactant.

Method of Application

The decontamination formulation can be prepared in a variety of forms, for example, in water, an aqueous solution or liquid, gel, strippable coating, mist or foam. Preferably the composition is prepared for dispersal as a foam using pressurized pumping equipment and/or aeration nozzles as would be known in the art.

Kits

The present invention also contemplates kits for preparing the decontamination compositions of the present invention. The kits may separately contain the individual components necessary to prepare the decontamination compositions or alternatively the kits may comprise two or more combinations of components necessary to prepare the decontamination compositions. The kits may also comprise mixing or dispersal systems, for example, one or more pumps, hoses, containers, nozzles, aerators, and the like, and instructions for preparing or using any component or combination of components that form part of the decontamination composition, or the decontamination composition itself.

One benefit of the surface decontamination composition described herein is that the components of the formulation are easy to mix and the final formulation can be made and be ready for use in little time as a liquid, foam, gel or the like. A further benefit of the surface decontamination composition, particularly when formulated into a foam, is that it is easily removed from surfaces by suction, rinsing or other means after decontaminating surfaces. The compositions as described herein also do not require special dispensing/application equipments and have good shelf/storage life when components of the composition are maintained in powder or separated form.

The decontamination formulations described herein are effective on single or multiple threat situations, for example, chemical, biological, radiological (or a combination of these threats). Further, compared to other prior art decontamination formulations, the compositions as described herein do not employ aggressive chemicals that are corrosive and could damage the surfaces to which the decontamination formulation is applied. Removal of the spent decontamination composition is also easy with minimal or no damaging of the surfaces by physical or mechanical means. Further, compared to some prior art methods, the composition described herein do not generate large volumes of waste and/or dust.

The present invention also contemplates methods of formulating, preparing and/or using the decontamination formulations as described herein and throughout.

### Experimental and Results

### 1. Decontamination Formulation Components and Test Surface Materials

### 1.1 Chemicals

Cesium chloride (99.999% CsCl, CAS 7647-17-8), cobalt nitrate hexahydrate (98% Co(NO₃)₂.6H₂O, CAS 10026-22-9), nitrilotriacetate (98%+C₆H₉N0₆, CAS 139-13-9), trisodium citrate (99%+Na₃C₆H₅O₇.2H₂O, CAS 6132-04-3), potassium hexacyanoferrate(IIII) (99.0%, K₃Fe(CN)₆, CAS 13746-66-2), ammonium nitrate (98%, NH₃NO₄ CAS 6484-52-2). No additional purification was performed.

### 1.2 Test Coupons

Construction materials used as surfaces for decontamination were six-year-old concrete, mosaic marble tiles, anodized aluminum and steel painted with gloss black Tremclad® paint. Three different sizes of coupon were used in experiments.

For bench scale non-radioactive tests, the size of coupons was 5×5 cm, while 3×3 cm for radioactive material. The thickness of the anodized aluminum and painted steel coupons were 0.3 cm whereas for concrete and marble it was 1 cm.

For large-scale demonstration tests, the size of coupons was 15×15 cm. The thickness of the anodized aluminum coupon was 0.3 cm whereas for concrete it was 4 cm.

### 2. Test Procedures Using Decontamination Liquids

### 2.1 Decontamination Studies with Non-Radioactive Cesium and Cobalt

### 2.1.1 Preparation of Coupon Contamination

Individual solutions containing 1000 mg/L of cesium and cobalt were prepared and used as contamination/spiking solutions. 20 spots of 1 μL each were placed on the upper surface of 5×5 cm of each test coupon. The total amount of contaminant on each test coupon was 20 μg.

The spiked coupons were left for at least 24 hours to dry before subjecting them to decontamination.

### 2.1.2 Formulation/Decontaminant Preparation

A. In a 1 L volumetric flask, add each of:
2.52 g ammonium nitrate,
2.52 g potassium hexacyanoferrate,
2.52 g trisodium citrate,
1.80 g of nitrilotriacetic acid
add distilled/deionized water to 500 mL.

B. Make up to 1 litre with deionized water and mix to dissolve.

This solution is preferably kept at room temperature for no longer than one week. If desired, the individual solid components can be combined in advance.

### 2.1.3 Decontamination Procedure

Each coupon was placed on a 45° angle in a decontamination jig. 10 mL of decontamination solution was applied on the surface of the contaminated coupon. After thirty minutes, the coupons were rinsed with 100 mL of deionized water. The runoff from each coupon was collected and the amount of contaminant removed was determined using Inductively Coupled Plasma Mass Spectrometry (ICP-MS). This value was then compared to the initial amount placed on the surface to calculate the percentage removal.

### 2.1.4 Analytical Procedure for Tests on Non-radioactive Isotopes

The non-radioactive cesium, cobalt, and strontium aqueous samples after ashing and filtering were analyzed in a fully quantitative analytical method on Thermo X Series II ICP-MS in standard mode. An internal standard of 100 ppb rhodium in 4% hydrochloric acid was used to monitor the analysis. The instrument was calibrated by 0.1 and 1 ppm Cs, Co, and Sr standard solutions before running samples and checked by the same solutions after running samples. Each sample was analyzed 3 times and an average was taken.

### 2.2 Decontamination studies with radioactive Cs-134 and Co-60

The SLOWPOKE-2 nuclear reactor was used for neutron activation. Energy and efficiency calibrations of the detector were performed using a multi-nuclide γ emitting radio-isotope source. Gamma-spectroscopy analysis was performed on an ORTEC GMX high-purity germanium detector.

### 2.2.1 Preparation of Contaminating/Spiking Solutions

Non-radioactive (cesium chloride (99.999% CsCl) and cobalt nitrate hexahydrate (98% Co(NO₃)₂.6H₂O)) salts were irradiated. A radioactive cesium solution was prepared by irradiating the salt in the SLOWPOKE-2 reactor and then dissolving it in methanol. A mass of 12.08 mg solid CsCl (9.54 mg Cs) was irradiated for 24 hours at 5×10¹¹ n·cm⁻²·s⁻¹ flux. Short-lived isotopes, such as chlorides, were allowed to decay, and the activity was measured to be 0.94 MBq. 9.5 mL of methanol was added to dissolve the salt. The resulting solution was used for all of the tests involving ¹³⁴Cs. Radioactive cobalt was prepared by directly irradiating a cobalt-containing methanol solution. 44.2 mg Co(NO₃)₂.6H₂O (8.77 mg Co based on manufacturer's label of 98% purity) was dissolved in methanol (total mass 2.0 g). After seven hours of irradiation in the SLOWPOKE-2 reactor the solution was centrifuged and decanted to obtain a clear solution with an activity 0.15 MBq.

### 2.2.2 Contamination/Spiking of Coupons

The coupons used for radiological studies had dimensions of 3×3× (0.3-1) cm. The thickness of the anodized aluminum and painted steel coupons were 0.3 cm whereas for concrete and marble it was 1 cm. The coupons were spiked by evenly applying ten 1-μL aliquots of the spiking solution on their upper surface of 3×3 cm. The coupons were then allowed to dry for at least 24 hours before the initial reading was taken.

### 2.2.3 Decontamination Procedure

The decontamination procedure comprised the following steps performed for each of the tests. The procedure was carried out with coupons placed in jigs with a containment tray so that decontamination runoff could be collected.
Coupons were placed at a 45° angle on a decontamination jig.
10 ml decontamination solution was applied evenly to each coupon surface using plastic syringes and left for 30 minutes.
The coupons were then rinsed with 50 mL of deionized water using plastic syringe.
The decontaminated coupons were left overnight to dry before activity was measured.

### 2.2.4 Analytical Procedure for Tests on Radioactive Isotopes

The γ-spectroscopy analysis of coupons was performed on an ORTEC GMX high-purity germanium detector. Prior to measurements, energy and efficiency calibration of the detector was performed using a certified geometry-specific multi-nuclide γ emitting radio-isotope source. The calibration source contained 11 radionuclides and was used to calibrate the detector over the range of 46.5-1810 keV. After calibration, a geometry-specific blank sample was counted, to ensure that the instrument dead time was below 1%. For the analyses, coupons were packed into polyethylene Petri-dishes of a 4.5-cm inner diameter, to avoid detector contamination. Appropriately sized O-rings were used as spacers to position the coupons in the center of the Petri-dishes. Samples were placed on the detector and γ spectra were recorded. Live-time counting was performed to ensure that the detection error would be below 2%. Spectra were recorded and analyzed using ORTEC 6.02 software for the integration of energy-specific peaks for particular isotopes.

### 3. Test Procedures Using Decontamination Foams

### 3.1 Prior Art Surface Decontamination Foam (SDF™)

Surface decontamination Foam (SDF™) available from Allen Vanguard is a decontamination formulation known in the art for chemical and biological agents and may have blast mitigation applications. A derivative of the Canadian Aqueous System for Chemical/Biological Agent Decontamination (CASCAD™) decontamination solution, SDF™ has been designed so that it can be used for an extended period of time and in a wide range of field environments. SDF™ is a chemical solution, dispensed as foam or a liquid, which destroys a variety of known military chemical and biological agents and holds radiological particles in suspension. SDF™ can be used with a variety of types of dispersion equipment.

### 3.2 Components of SDF™

a) Primary Agent Component comprises by weight:
70-100% Dichloroisocyanuric acid, sodium salt in powder or aqueous form
   b) Buffer Component System (in solid/powder form or aqueous solution) comprises by weight:
Sodium tetraborate 10-30%,
Sodium hydroxide 1-5%,
Sodium carbonate 40-65%,
   c) Surfactant Component System (formulated as individual components only or in aqueous solution (by weight))
Sodium myristeth sulphate 10-30%,
Sodium C14-C16 Olefin sulfonate 10-30%,
Ethanol denatured 3-9%,
C10-16 Alcohols 5-10%,
Sodium sulphate 3-7%,
Sodium xylene sulphonate 1-5% and
proprietary mixture of sodium and ammonium salts with water and co-solvent >9%

### 3.3 Universal Surface Decontamination Formulations (USDF)

Universal Surface Decontamination Formulation (USDF) is based on composition of SDF but also has radionuclide sequestering agents added to it. This is to enhance radiological/nuclear decontamination effectiveness. This will make the formulation universal capable of dealing with all three threats, i.e., chemical, biological, and radiological agents.

### 3.4 Preparation of Surface Decontamination Formulation (SDF™) and Universal Surface Decontamination Formulations (USDF)

### 3.4.1 Preparation of SDF:

Step 1:

In a 50 mL graduated cylinder;
Add 1.8 grams of Buffer Component System (see section 3.2),
Add 4.5 mL of Surfactant Component System (see section 3.2),
Add distilled water to 50 mL, Mix until dissolved;

Step 2:

Place 40 mL water in a second beaker or cylinder,
Add 7.8 grams of Primary Agent Component (see section 3.2),
Add water to 50 mL, Mix until dissolved,

Step 3:

Measure out 50 mL of water.

Immediately prior to testing, combine all solutions obtained from steps 1 to 3 to yield 150 mL total volume and place in a Waring Blender (Commercial Waring Blender (Model 31BL92) with impeller (AV # PN4118675)) or other appropriate mixing device.

Mix for 7-10 seconds in the blender on high speed to produce foam (foam will essentially fill a standard size mixing bowl). Apply immediately 5 ml of resulting foam to each test coupon.

### 3.4.2 Preparation of Stock and Universal Surface Decontamination Formulations (USDF):

### 3.4.2.1 Stock Formulation Preparation

A. In a 1 L volumetric flask, add each of:
2.52 g ammonium nitrate (NH₃NO₄ CAS 6484-52-2),
2.52 g potassium hexacyanoferrate (K₃Fe(CN)₆, CAS 13746-66-2),
2.52 g trisodium citrate (Na₃C₆H₅O₇.2H₂O, CAS 6132-04-3),
1.80 g of nitrilotriacetic acid (C₆H₉NO₆, CAS 139-13-9)
add distilled/deionized water to 500 mL.

B. Make up to 1 litre with deionised water and mix to dissolve.

This stock solution is preferably kept at room temperature for no longer than one week. If desired, the individual solid components can be combined in advance.

### 3.4.2.2 Preparation of Universal Surface Decontamination Foam (USDF)

Step 1:

In a 50 mL graduated cylinder;
Add 1.8 grams of Buffer Component System (see section 3.2),
Add 4.5 mL of Surfactant Component System (see section 3.2);
Add distilled water to the 50 mL; mix until dissolved;

Step 2:

Place 40 mL water in a second beaker or cylinder
Add 7.8 grams of Primary Agent Component (see section 3.2)
Add water to 50 mL, Mix until dissolved

Step 3:

Measure 50 mL of the Stock Formulation Solution. (Refer to section 3.4.2.1).
Once ready to test, combine solutions prepared from steps 1, 2 and 3 to yield 150 mL total volume and place in a Waring Blender or other appropriate mixing device
Mix for 7-10 seconds in the Waring Blender on high speed; foam will essentially fill the mixing bowl, and;
Immediately apply 5 ml of resulting foam to each test coupons if testing.
3.4.3 Decontamination of Coupons Contaminated with Non-Radioactive Cesium, Cobalt and Strontium

### 3.4.3.1 Preparation of Test Coupons

Individual solutions containing 1000 mg/L of cesium, cobalt and strontium were prepared and used as contamination/spiking solutions. 20 spots of 1 μL each were placed on each 5×5 cm test coupon. The total amount of contaminant on each test coupon was 20 μg. The spiked coupons were left for at least 24 hours to dry before subjecting them to decontamination.

### 3.4.3.2 Coupon Decontamination Procedure

Each coupon was placed on a 45° angle in a decontamination jig. 10 mL of decontamination solution or foam was placed on the surface of the 5×5 cm coupon. After thirty minutes, the coupons were rinsed with 100 mL of deionized water. The runoff from each coupon was collected and the amount of contaminant removed was determined. This value was then compared to the initial amount placed on the surface to calculate the percentage removal.

### 3.5 Decontamination of Coupons Contaminated with Radioactive Material

### 3.5.1 Preparation of Radioactive Test Coupons

The coupons used for radiological studies had dimensions of 3×3×(0.3−1) cm. They were spiked by evenly applying ten 1 μL aliquots of the irradiated spiking solutions of cesium or cobalt on their upper surface of 3×3 cm. The coupons were then allowed to dry for 1 to 2 weeks before the initial reading was taken.

### 3.5.2 Coupon Decontamination Procedure

The decontamination procedure comprised the following steps, performed in triplicate for each of the tests. The procedure was carried out with the jigs placed in a containment tray so that the decontamination runoff could be collected.
1. The coupons were placed at a 45° angle on a decontamination jig.
2. An amount of 5 mL of the decontamination composition (foam or liquid, depending on the formulation) was applied evenly to each surface.
3. The decontamination composition was allowed to sit for 30 minutes.
4. After 30 minutes, the coupons were rinsed with 50 mL of deionized water.

### 4. Large-Scale Decontamination of Concrete and Anodized Aluminum

### 4.1 Reagent Preparation

### 4.1.1 Reagent A: for Use in USDF Formulation:

In a 1 L volumetric flask, add each of:
2.66 g ammonium nitrate (NH₃NO₄ CAS 6484-52-2),
2.66 g potassium hexacyanoferrate (K₃Fe(CN)₆, CAS 13746-66-2),
2.66 g trisodium citrate (Na₃C₆H₅O₇.2H₂O, CAS 6132-04-3),
1.90 g nitrilotriacetic acid (C₆H₉NO₆, CAS 139-13-9) to approximately
   Bring to approximately 500 mL with deionised water. Stopper and shake to dissolve.
   Make up to 1 litre with deionised water.
   The solution can be kept at room temperature for one week.
   4.1.2 Reagent B: as Rinse Solution for Use after Two Applications of USDF

In a 1 L volumetric flask, add each of:
2.52 g ammonium nitrate (NH₃NO₄ CAS 6484-52-2),
2.52 g potassium hexacyanoferrate (K₃Fe(CN)₆, CAS 13746-66-2),
2.52 g trisodium citrate (Na₃C₆H₅O₇.2H₂O, CAS 6132-04-3),
1.80 g of nitrilotriacetic acid (C₆H₉NO₆, CAS 139-13-9),
   Bring to approximately 500 mL with deionised water. Stopper and shake to dissolve.
   Make up to 1 litre with deionised water.
   The solution can be kept at room temperature for one week.

### 4.2 Test/Application Procedure

### 4.2.1 For USDF Technology

1. Combine the following components into the mixing vessel of the air trolley:
   a. 6.6 L water,
   b. 485 g Primary Agent Component, (Refer to section 3.2 (a))
   c. 110 g Buffer Component System. (Refer to section 3.2 (b))
2. Stir until all particulates have dissolved.
3. Add 2×950 mL bottles of Surfactant Component System (Refer to section 3.2 (c))
4. Add 1 L of Reagent A
5. Pressurize the mixing vessel.
6. From a distance of approximately 10 ft, evenly spray ⅓ of the foam (approximately 3 L of contents in applicator) on the wall making sure to cover all coupons and surfaces. The entire contents of the applicator will expand to produce foam that is approximately 30 L.
7. Allow the foam to stay on the wall for 30 minutes.
8. When the time has elapsed, vacuum to retrieve the foam.
9. Using an agricultural mist sprayer, rinses the surface by evenly distribute water across the wall working from the top to the bottom so that all of the foam is removed from the wall.
10. Vacuum the surface.
2. Repeat steps 6-10, for a total of 2 passes.
3. Rinse the surface with Reagent B and wait for 30 minutes
4. Rinse surface with water
5. Vacuum the surface

### 4.2.2 Evaluation of USDF

Regardless of surface type USDF was applied to the coupons in the same way. Nine coupons placed on the 3 meter (m) by 3 m test wall (eight contaminated and one cross contamination blank) were decontaminated at one time. The application of USDF was performed using a foamer (Concealed Backpack Foamer, Allen-Vanguard, Ottawa, ON, Canada) following instructions provided by Allen-Vanguard. The application included loading the foamer with liquid foam (constituents given in the instructions), pressurization of the foamer to 2,500 pounds per square inch (psi) with compressed carbon dioxide, and application of the foam to the surface coupons so the coupons were completely covered. The foam was allowed to reside on the surface for 30 minutes and then the foam (and water rinse) was removed using a vacuum (6.5 horsepower, ShopVac® QSP® Quiet Deluxe®, Williamsport, Pa.) mounted on top of a 65 gallon vacuum collection reservoir (1065-YE Poly Over Pak® 65, Enpac, Eastlake, Ohio) containing a defoaming reagent to diminish the volume of the foam when vacuumed. The defoaming reagent was recirculated from the collection reservoir into the vacuum wand so the foam would not clog the vacuum hose. The last step involved rinsing the surface of each coupon with deionized water using a handheld sprayer (Model 1125D Wood and Masonry Sprayer, Root-Lowell Flo Master®, Lowell, Mich.) and then vacuuming again.

Following the two foam applications, rinses, and removals, another reagent (referred to as Reagent B) was applied to the surfaces using the handheld sprayer. This reagent had the consistency of water with a light yellow color. After application using the handheld sprayer, the Reagent B was left on the surfaces for 30 minutes and then the surfaces were rinsed with distilled water and vacuumed.

### 5. Chemical and Biological Decontamination Tests

The SDF and USDF compositions were also tested for their abilities to decontaminate chemical warfare agents and biological agents.

### 5.1 Test Procedure for Chemical Warfare Agents

The decontamination procedure utilized was NATO/PFP ANNEX C STANAG 4360, which is the standardized testing methodology for evaluating the decontamination efficacy of chemical warfare agents.

### 5.2 Test Procedure for Biological Agents

| Biological Agent | Test Method |
|---|---|
| a) Staphylococcus | AOAC Use-Dilution Official Test Method 955.15 |
| aureus | |
| b) Pseudomonas | AOAC Use-Dilution Official Test Method 964.02 |
| aeruginosa | |
| c) Salmonella enterica | AOAC Use-Dilution Official Test Method 955.14 |
| d) Trichophyton | AOAC Use Dilution Test modified for fungi as |
| mentagrophytes | per EPA's new 810 guidelines |
| e) Human Influenza A | “Standard Test Method for Efficacy of |
| Virus (H1N1) | Virucidal Agents Intended for Inanimate |
| | Environmental Surfaces” |
| | ASTM standard E1053-97 (Reapproved |
| | 2002) |
| f) Feline calicivirus | “Standard Test Method for Efficacy of |
| (Surrogate for Human | Virucidal Agents Intended for Inanimate |
| norovirus) | Environmental Surfaces” |
| | ASTM standard E1053-97 (Reapproved |
| | 2002) |

### 6. Results

### Example 1

### 6.1 Decontamination Tests with Non-Radioactive Material

6.1.1 Decontamination Tests with Salts in Water

Table 1 and 2 summarizes decontamination efficiency of the decontamination composition in water for the removal of non-radioactive cesium and cobalt from various surface materials.

TABLE 1
Removal of cesium (non-radioactive) from building materials using
formulation salts in water (ammonium nitrate, potassium
hexacyanoferrate, trisodium citrate and nitrilotriacetic acid)

| Surface Material | % Removal of Cesium |
|---|---|
| Concrete | 43.5 |
| Marble | 66.4 |
| Painted Steel | 92.4 |
| Anodized Aluminum | 94.2 |

TABLE 2
Removal of cobalt (non-radioactive) from building
materials using formulation salts in water (ammonium
nitrate, potassium hexacyanoferrate, trisodium
citrate and nitrilotriacetic acid)

| Surface Material | % Removal of Cobalt |
|---|---|
| Concrete | 53.6 |
| Marble | 56.8 |
| Painted Steel | 94.7 |
| Anodized Aluminum | 94.1 |

6.1.2 Decontamination Tests with USDF

The results of testing decontamination compositions comprising varying amounts of ammonium nitrate, potassium hexacyanoferrate, trisodium citrate and nitrilotriacetic acid are shown in Tables 3 and 4.

TABLE 3
Decontamination of concrete from cesium, cobalt and strontium
using original SDF, USDF with various concentrations of
salts (ammonium nitrate, potassium hexacyanoferrate, trisodium
citrate and nitrilotriacetic acid in SDF)

| | % Removal | | |
|---|---|---|---|
| Decontaminants | Cesium | Cobalt | Strontium |
| SDF original | 19.2 | 17.3 | 14.4 |
| USDF (contains 0.00025% of each salt ) | 19.8 | 19.9 | 15.8 |
| USDF (contains 0.0025% of each salt) | 21.1 | 22.3 | 24.7 |
| USDF (contains 0.025% of each salt)) | 24.7 | 24.1 | 30.6 |
| USDF (contains 0.25% of each salt) | 31.7 | 26.9 | 38.6 |

TABLE 4
Decontamination of painted steel from cesium, cobalt and strontium
using original SDF, USDF with various concentrations of salts

| | % Removal | | |
|---|---|---|---|
| Decontaminants | Cesium | Cobalt | Strontium |
| SDF original | 81.5 | 75.8 | 71.2 |
| USDF (contains 0.0025% of each salt) | 82.7 | 79.3 | 79.3 |
| USDF (contains 0.025% of each salt)) | 83.8 | 85.5 | 91.2 |
| USDF (contains 0.25% of each salt) | 93.5 | 96.9 | 99.5 |

The results shown in Tables 3 and 4 suggest that various concentrations of ammonium nitrate, potassium hexacyanoferrate, trisodium citrate and nitrilotriacetic acid in SDF formulations can be employed as decontamination compositions and provide improved results over SDF alone.

Additional tests were completed to determine the effect of single salt additives to SDF formulations. The results of tests are shown in Tables 5 and 6.

TABLE 5
Decontamination of concrete from cesium using addition of
individual salts to SDF (A: Ammonium salt, B: Hexacyanoferrate
C: nitrilotriacetic acid D: trisodium citrate)

| SDF with various salt combinations | % Removal of Cesium |
|---|---|
| SDF original | 19.2 |
| SDF + A | 21.6 |
| SDF + B | 27.2 |
| SDF + A + B | 31.9 |
| USDF (SDF + A + B + C + D) | 31.7 |

TABLE 6
Decontamination of cobalt and strontium from
concrete using addition of individual salts to
SDF (A: Ammonium salt, B: Hexacyanoferrate C:
nitrilotriacetic acid D: trisodium citrate)

% Removal

| SDF with various salt combinations | Cobalt | Strontium |
|---|---|---|
| SDF original | 15.1 | 15.1 |
| SDF + C | 20.3 | 26.8 |
| SDF + D | NA | 22.6 |
| SDF + C + D | 23.8 | 37.7 |
| USDF (SDF + C + D + A + B) | 25.0 | 38.0 |

The salts were selected on the basis of their effectiveness towards target contaminants. Ammonium nitrate and potassium hexacyanoferrate are effective on cesium, while nitrilotriacetic acid and trisodium citrate are effective on cobalt and strontium.

The results suggest that independent addition of ammonium salt, hexacyanoferrate, nitrilotriacetic acid or trisodium citrate to surface decontamination foam known in the art produces a formulation that exhibits improved decontamination results and that the addition of more of these components generally provides even better decontamination results than when a single component is employed.

Table 7-9 shows the decontamination efficiencies of SDF and USDF on non-radioactive isotopes. USDF exhibits better removal in comparison with original SDF.

TABLE 7
Removal of Cesium (non-radioactive)
from surfaces using SDF and USDF

% Removal of cesium

| Surface Material | SDF | USDF |
|---|---|---|
| Concrete | 19.2 | 31.7 |
| Marble | 26.8 | 58.5 |
| Painted Steel | 81.5 | 93.5 |
| Anodized Aluminum | 89.2 | 96.6 |

TABLE 8
Removal of Cobalt (non-radioactive)
from surfaces using SDF and USDF

% Removal of cobalt

| Surface Material | SDF | USDF |
|---|---|---|
| Concrete | 17.3 | 26.9 |
| Marble | 24.2 | 52.5 |
| Painted Steel | 75.8 | 96.9 |
| Anodized Aluminum | 72.2 | 92.1 |

TABLE 9
Removal of Strontium (non-radioactive)
from concrete using SDF and USDF

% Removal of strontium

| Surface Material | SDF | USDF |
|---|---|---|
| Concrete | 14.4 | 38.6 |
| Marble | 23.7 | 46.4 |
| Painted Steel | 71.2 | 99.5 |
| Anodized Aluminum | 64.0 | 91.1 |

### Example 2

### 6.2 Decontamination Tests on Radioactive Material

### 6.2.1 Decontamination Tests Using Formulation Components in Water

Tables 10 and 11 summarize decontamination efficiency of the decontamination composition in water for the removal of radio active cesium and cobalt from various surface materials.

TABLE 10
Removal of radioactive cesium-134 from building
materials using formulation components in water

| Surface Material | % Removal of Cesium-134 |
|---|---|
| Concrete | 48.0 |
| Marble | 67.0 |
| Painted Steel | 99.1 |
| Anodized Aluminum | 98.7 |

TABLE 11
Removal of radioactive cobalt-60 from building
materials using formulation components in water

| Surface Material | % Removal of Cobalt-60 |
|---|---|
| Concrete | 52.9 |
| Marble | 61.5 |
| Painted Steel | 95.8 |
| Anodized Aluminum | 97.8 |

### 6.2.1 Decontamination Tests Using SDF and USDF

Tables 12-14 summarize decontamination efficiency of original SDF and USDF for the removal of radio active cesium, cobalt and strontium from various surface materials.

TABLE 12
Removal of radioactive Cesium-134 from
surfaces using original SDF and USDF

% Removal of Cesium-134

| Surface Material | SDF | USDF |
|---|---|---|
| Concrete | 20.1 | 34.8 |
| Marble | 24.3 | 52.0 |
| Painted Steel | 80.5 | 88.4 |
| Anodized Aluminum | 96.9 | 99.0 |

TABLE 13
Removal of radioactive Cobalt-60
from surfaces using SDF and USDF

% Removal of Cobalt-60

| Surface Material | SDF | USDF |
|---|---|---|
| Concrete | 8.6 | 24.6 |
| Marble | 24.3 | 51.7 |
| Painted Steel | 75.6 | 96.2 |
| Anodized Aluminum | 81.2 | 92.2 |

TABLE 14
Removal of radioactive Strontium-85
from surfaces using SDF and USDF

% Strontium-85

| Surface Material | SDF | USDF |
|---|---|---|
| Concrete | 14.4 | 41.0 |

### Example 3

### 6.3 Pilot/Large Scale Decontamination Tests on Radioactive Cs-137

Table 15 summarizes the decontamination efficiency of USDF on concrete and anodized aluminum when tested on pilot/large scale using cesium-137.

TABLE 15
Pilot/Large scale testing for the decontamination of
radioactive Cs-137 from Concrete and Anodized Aluminum
using Universal Surface Decontamination Foam (USDF)

| Surface Material | % Removal of Cesium-137 |
|---|---|
| Concrete | 62.0 |
| Anodized Aluminum | 92.0 |

### Example 4

### 7. Chemical and Biological Decontamination Test Results

TABLE 16
Decontamination of Chemical Warfare Agents (CWA) with SDF and USDF

| | % Decontamination | | | | | | | |
|---|---|---|---|---|---|---|---|---|
| | Painted | | | | | | Anodized | |
| | Drywall | | Ceramic Tile | | Painted Steel | | Aluminum | |
| Agent | SDF | USDF | SDF | USDF | SDF | USDF | SDF | USDF |
| HD Sulfur Mustard | 98.5 | 95.6 | 100 | 99.8 | 95.2 | 94.6 | 100 | 100 |
| GD Soman | 88.8 | 76.1 | 99.6 | 99.6 | 85.3 | 86.7 | 100 | 100 |
| GF Nerve Agent | 86.7 | 93.2 | 98.5 | 100 | 83.7 | 85.7 | 100 | 100 |
| VX V Series Nerve | 81.4 | 98.3 | 100 | 100 | 64.0 | 58.1 | 100 | 100 |
| Agent | | | | | | | | |

The results shown in Table 16 suggest that the universal surface decontamination formulations are effective compositions for decontamination of a variety of chemical warfare agents. The results also confirm that the added compounds are compatible with original SDF formulation and did not significantly inhibit its chemical and biological decontamination capabilities. The results of testing the decontamination compositions on biological agents are provided in Table 17.

TABLE 17
Decontamination of Biological Agents using SDF
and USDF (Results are expressed as Number of Tubes
Exhibiting Growth/Total Number of Tubes)

| Agents | SDF | USDF |
|---|---|---|
| Staphylococcus aureus | 0/60 | 0/60 |
| Pseudomonas aeruginosa | 0/60 | 0/60 |
| Salmonella enterica | 0/60 | 0/60 |
| Trichophyton mentagrophytes | 0/10 | 0/10 |
| Human Influenza | Inactivation of | Inactivation of |
| A Virus (H1N1) | challenge virus and | challenge virus and |
| | no cytotoxicity at | no cytotoxicity at |
| | various dilutions | various dilutions |
| Feline calicivirus | Inactivation of | Inactivation of |
| (Surrogate for | challenge virus and | challenge virus and |
| Human norovirus) | no cytotoxicity at | no cytotoxicity at |
| | various dilutions | various dilutions |

The results shown in Table 17 suggest that the universal decontamination composition is an effective composition for decontamination of a variety of biological agents.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A decontamination composition which is a combination of dissolved decontamination treatment compounds in water, wherein the compounds are ammonium nitrate in an amount of 15% or less, potassium ferricyanide in an amount of 15% or less, nitrilotriacetate in an amount of 20% or less and a citrate compound in an amount of 20% or less; all weight percentages based on the weight of the decontamination composition.

2. A decontamination composition comprising an ammonium compound, a ferricyanide/ferrocyanide compound, a polyaminocarboxylic acid compound, a polycarboxylic compound, and water; wherein the composition is a fluid composition and wherein the ferricyanide/ferrocyanide compound is a water soluble ferricyanide/ferrocyanide compound dissolved in the fluid; wherein the ammonium compound is ammonium nitrate present in an amount of 0.0001-15% by weight, the ferricyanide/ferrocyanide compound is potassium ferricyanide present in an amount of 0.0001% to 15% by weight, the polyaminocarboxylic acid compound is nitrilotriacetate present in an amount of 0.0001% to 20% by weight, and the polycarboxylic acid compound is a citrate present in an amount of 0.0001% to 20% by weight.

3. The decontamination composition of claim 1, formulated for dispersal as a foam.

4. The decontamination composition of claim 1, comprising a further oxidizing agent or an isocyanuric acid.

5. The decontamination composition of claim 1, further comprising dichloroisocyanuric acid.

6. The decontamination composition of claim 1, wherein the composition comprises one or more surfactants.

7. The decontamination composition of claim 1, wherein the composition comprises one or more compounds that result in an alkaline buffer.

8. The decontamination composition of claim 1, wherein the composition further comprises a propylene glycol, polyethylene glycol, derivative of propylene glycol, derivatives of polyethylene glycol or a combination thereof.

9. The decontamination composition of claim 1, comprising a) ammonium ions, b) hexacyanoferrate, c) citrate, d) nitrilotriacetic acid, e) dichloroisocyanuric acid, f) carbonate, g) one or more surfactants comprising sodium myristeth sulfate, C14-C16 olefin sulfonate, denatured ethanol, or C10-C16 alcohols and h) polyethylene glycol, propylene glycol or a derivative thereof.

10. The decontamination composition of claim 1, wherein the polycarboxylic acid compound is sodium citrate.

11. The decontamination composition of claim 1, wherein ammonium nitrate, potassium hexacyanoferrate and citrate are each present in the composition in an amount by weight that is greater than nitrilotriacetate and each of ammonium nitrate, potassium hexacyanoferrate, nitrilotriacetate and citrate are present in the composition in an amount that is close to saturation.

12. The decontamination composition of claim 11, wherein the amount by weight of each of ammonium nitrate, potassium hexacyanoferrate and citrate are about the same.

13. The decontamination composition of claim 12, wherein each of ammonium nitrate, potassium hexacyanoferrate, nitrilotriacetate and citrate are present in the composition in an amount that is close to saturation.

14. A kit comprising,
a) the decontamination composition of claim 1, and
b) one or more mixers, pumps, hoses, containers, nozzles, or aerators for dispersing the composition as a liquid or foam.

15. A fluid decontamination composition comprising an ammonium compound, a ferricyanide/ferrocyanide compound, a polyaminocarboxylic acid compound, a polycarboxylic compound, and water; wherein the composition is a fluid composition and wherein the ferricyanide/ferrocyanide compound is water soluble and is dissolved in the fluid; wherein the ammonium compound is present in an amount of 0.0001-15% by weight, the ferricyanide/ferrocyanide compound is present in an amount of 0.0001% to 15% by weight, the polyaminocarboxylic acid compound is present in an amount of 0.0001% to 20% by weight, and the polycarboxylic acid compound is present in an amount of 0.0001% to 20% by weight.

16. The decontamination composition of claim 15, wherein the ammonium compound, ferricyanide/ferrocyanide compound and polycarboxylic acid are each present in the composition in an amount by weight that is greater than the polyaminocarboxylic acid.

17. The decontamination composition of claim 15, wherein each of the ammonium compound, ferricyanide/ferrocyanide compound, polyaminocarboxylic acid and polycarboxylic acid are present in the composition in an amount of up to saturation.

18. The decontamination composition of claim 15, wherein the amount by weight of each of the ammonium compound, ferricyanide/ferrocyanide compound and polycarboxylic acid are about the same.

19. The decontamination composition of claim 15, wherein each of ammonium compound, potassium hexacyanoferrate, nitrilotriacetate and citrate are present in the composition in an amount that is close to saturation.

20. A kit comprising,
a) the decontamination composition of claim 15, and
b) one or more mixers, pumps, hoses, containers, nozzles, or aerators for dispersing the composition as a liquid or foam.
